(19) United States
(12) Patent Application Publication
(10) Pub. No.: US 2006/0169132 A1
(43) Pub. Date: Aug. 3, 2006

(54) Linear hydraulic actuator

(76) Inventor: David Roy Tucker, Cravon Arms (GB)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/342,189

(22) Filed: Jan. 27, 2006

(30) Foreign Application Priority Data
Jan. 29, 2005 (GB) 0501893.2

(51) Int. Cl. F15B 15/22

(52) U.S. Cl. 92/8; 92/52

(57) ABSTRACT

A linear hydraulic actuator comprises,
an outer hydraulic cylinder (11) of internal axial length l₁,
a hollow cylindrical slide member(17) of axial length l₂, where l₂ is less than l₁, said slide member (17) being received coaxially within said outer cylinder (11) and being engaged in sealed sliding relationship with the inner surface of said outer cylinder (11),
a piston assembly (19) received coaxially within said outer cylinder (11) and said slide member (17) and including a piston head (21) engaged in sealed sliding relationship with the inner surface of said slide member (17) and a piston rod (22) extending from one axial end of said slide member (17) and further extending, in sealed sliding relationship, through one end of said outer cylinder (11).
first stop means define first and second axially spaced limit positions of the axial sliding movement of said slide member (17) relative to said outer cylinder (11), and
second stop means define first and second axially spaced limit positions of the axial movement of said piston assembly (19) relative to said slide member (17).

This invention relates to a linear hydraulic actuator of the kind including an hydraulic piston and cylinder arrangement, the piston of which can be moved in extend and retract directions relative to the cylinder by application of hydraulic fluid under pressure to the piston within the cylinder.

Linear hydraulic actuators are used in a wide variety of mechanisms, but a particularly convenient environment for consideration herein is the actuation of a thrust reverser system in an aircraft gas turbine engine where the cowl, or other movable component, of the reverser system is moved between deployed and stowed positions by a linear hydraulic actuator. It is to be understood however that the present invention is not restricted to aircraft engine thrust reverser actuators.

In some applications, retraction of the cowls of a gas turbine engine thrust reverser system being a good example, the force which must be generated by the actuator, when the piston is being moved from one limit position relative to the cylinder, is greater at the commencement of the movement from the limit position than the force needed to continue the movement of the piston when the piston has moved a certain distance from the limit position. It is an object of the present invention to provide a linear actuator which can achieve the forces necessary both at commencement of the stroke, and during the stroke, while minimising the amount of hydraulic fluid required, and thus minimising the capacity of the associated hydraulic fluid pressure supply system.

In accordance with the present invention there is provided a linear hydraulic actuator comprising,

an outer hydraulic cylinder of internal axial length l₁,

a hollow cylindrical slide member of axial length l₂, where l₂ is less than l₁, said slide member being received coaxially within said outer cylinder and being engaged in sealed sliding relationship with the inner surface of said outer cylinder,

a piston assembly received coaxially within said outer cylinder and said slide member and including a piston head engaged in sealed sliding relationship with the inner surface of said slide member and a piston rod extending from one axial end of said piston head and further extending, in sealed sliding relationship, through one end of said outer cylinder,

first stop means defining first and second axially spaced limit positions of the axial movement of said slide member relative to said outer cylinder, and

second stop means defining first and second axially spaced limit positions of the axial sliding movement of said piston assembly relative to said slide member,

whereby, in use, with said piston assembly at said first limit position of its axial movement relative to said slide member and said slide member at said first limit position of its axial movement relative to the outer cylinder, then application of hydraulic fluid pressure to the interior of said outer cylinder, at one axial end thereof, simultaneously drives the slide member and the piston assembly away from their respective first limit positions towards their respective second limit positions, said hydraulic pressure acting on both the exposed area of the piston head and on the annular end surface of said slide member, said movement of said slide member and said piston assembly in unison continuing until said slide member is arrested in its second limit position by said first stop means, whereafter said piston assembly continues to move, sliding within the slide member under the action of hydraulic pressure applied to the exposed area of the piston head, until the piston assembly is arrested in its second limit position relative to the slide member by said second stop means.

Preferably hydraulic fluid under pressure can be admitted to, and discharged from, the interior of said cylinder at said one axial end thereof through a first fluid port, and a second fluid port is provided adjacent the opposite axial end of the cylinder for the admission, or discharge of hydraulic fluid.

Preferably said piston assembly and said slide member can be driven hydraulically from their second limit positions towards their first limit positions by hydraulic fluid pressure at the opposite axial end of said cylinder.

Desirably a change-over valve controls the connection of at least one of said first and said opposite axial ends of the cylinder to high pressure and low pressure lines.

Conveniently hydraulic fluid under equal high pressure is supplied to both axial ends of said cylinder when moving said piston assembly and said slide member from said second limit positions towards said first limit positions so that hydraulic pressures acting on the slide member are balanced, and said slide member is moved to its first limit position by the piston assembly.

Preferably said piston assembly is hollow and at the end of the cylinder remote from the piston rod the cylinder defines a pressure chamber the wall of which is defined in part by an annular end surface of said hollow piston assembly, the actuator further including sealing means fixed with respect to said cylinder and slidably engaging the interior surface of said hollow piston assembly to isolate an inner, closed, end chamber of said hollow piston assembly from said pressure chamber, and, a fluid flow path between said inner, closed, end chamber of said hollow piston assembly and a port of said actuator connected in use to a pressurised hydraulic fluid supply line, said fluid flow path including a flow restrictor whereby the rate at which hydraulic fluid can enter said inner, closed, end chamber of said hollow piston assembly from said supply line is less than the rate at which the volume of said inner, closed end chamber increases as said piston assembly is moved by the application of hydraulic fluid to said pressure chamber.

Preferably a non-return valve is associated with said fluid flow path so that during movement of said piston assembly relative to said cylinder to discharge hydraulic fluid from the interior of the piston assembly through said path, said valve opens so that fluid discharged from the interior of said hollow piston assembly is not required to flow through said restrictor.

Desirably said sealing means is carried by a rod disposed coaxially within said hollow piston assembly and secured to the cylinder.

Conveniently said fluid flow path includes a passage extending through said rod.

Desirably said non-return valve is carried by said rod.

Conveniently said passage through said rod interconnects said pressure chamber and said end chamber.

Conveniently said restrictor and said non-return valve are defined by a common component in the form of a non-return valve which leaks in its closed position to permit a restricted flow of hydraulic fluid from said supply line to said end chamber.

Examples of the invention are illustrated in the accompanying drawings wherein:

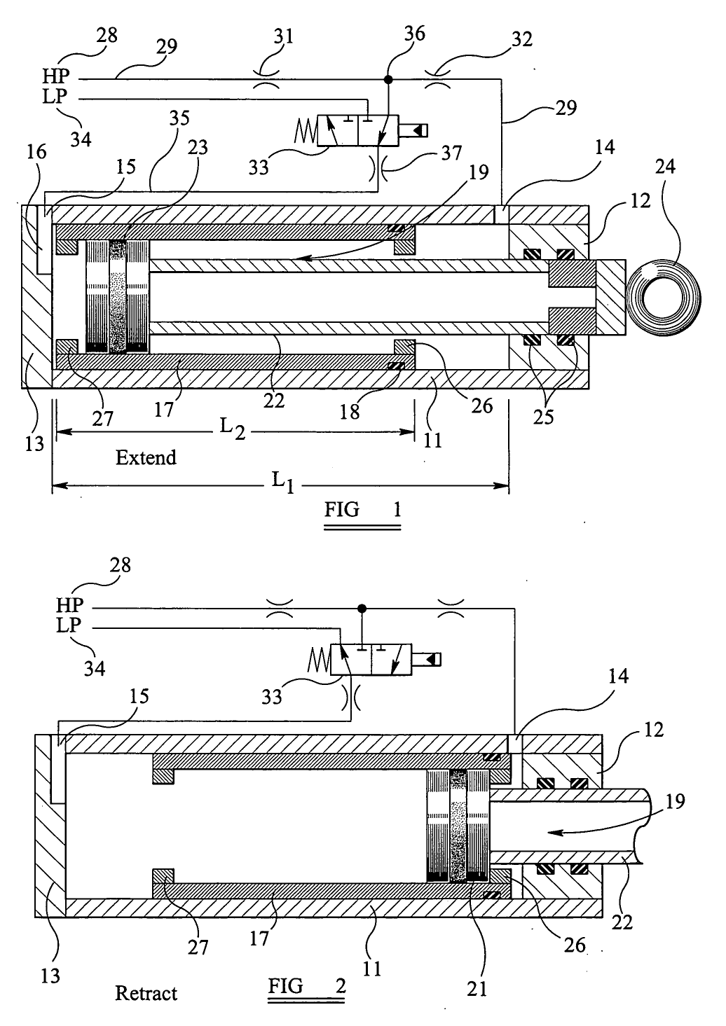

FIG. 1 is a diagrammatic cross-sectional view of a linear hydraulic actuator and a control valve associated with the actuator at the commencement of an extending stroke of the actuator;

FIG. 2 is a view similar to FIG. 1 showing the parts at the commencement of a retraction stroke of the actuator; and,

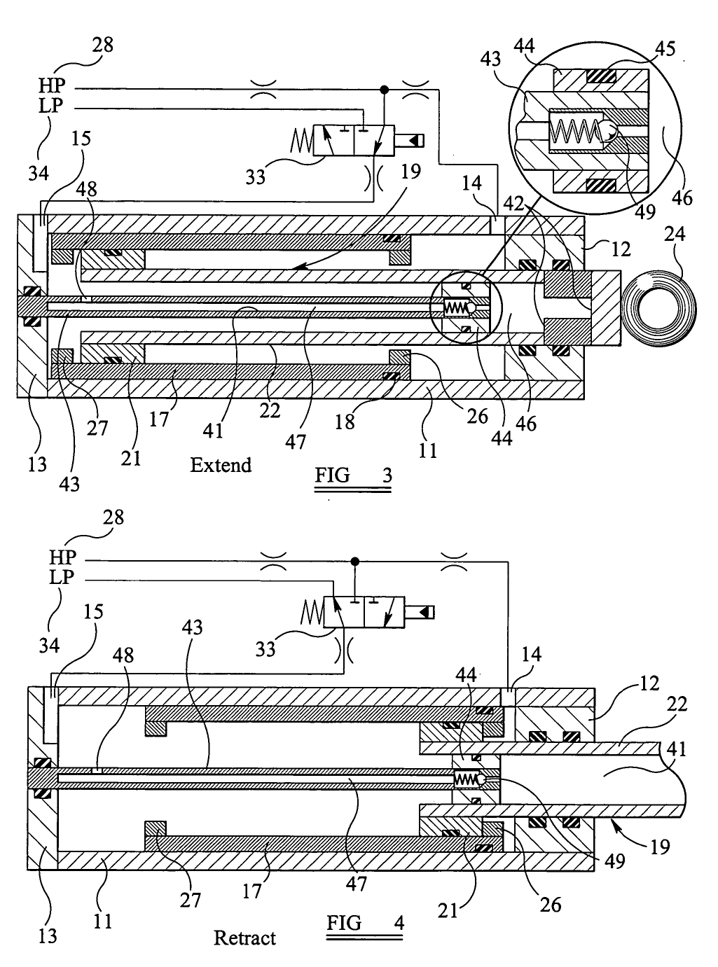

FIGS. 3 and 4 are views similar to FIGS. 1 and 2 of a modification of the actuator of FIGS. 1 and 2.

Referring first to FIGS. 1 and 2 of the accompanying drawings it can be seen that the linear hydraulic actuator includes an outer hydraulic cylinder 11 having an annular bush 12 partially closing one axial end of the cylinder, and an end cap 13 closing the opposite axial end of the cylinder. Adjacent the bush 12 the wall of the cylinder 11 is formed with a first hydraulic fluid port 14, and a similar second port 15 communicating with a recess 16 in the inner face of the end cap 13, is provided at the opposite axial end of the cylinder 11. Slidably received within the cylinder 11 is a hollow cylindrical slide member 17, the member 17 being coaxial with the cylinder 11 and having its outer face slidably engaging the inner face of the cylinder 11. A sealing ring 18 carried by the slide member 17 seals the sliding interface of the member 17 and the cylinder 11. It is clear from FIG. 1 that the internal axial length 1, of the cylinder 11 significantly exceeds the axial length 12 of the slide member 17. The cylinder 11 and slide member 17 define first stop means providing first and second limit positions of the sliding movement of the slide member 17 within the cylinder 11. The first limit position is when the right hand end (in FIG. 1) of the slide member 17 is closely adjacent the inner face of the bush 12, and the second limit position is when the left hand end (as shown in FIG. 1) of the slide member 17 abuts the inner face of the end cap 13. Thus the permitted stroke of the slide member 17 is 1, minus 12.

The actuator further includes a piston assembly 19 comprising a piston head 21 and piston rod 22 rigidly affixed to the piston head 21 and extending axially therefrom. The piston assembly 19 is disposed coaxially within the cylinder 11 and slide member 17 and the piston head 21 slidably engages the inner surface of the slide member 17, a sealing ring 23 carried by the piston head 21 sealing the sliding interface of the piston head 21 and the slide member 17. The piston rod 22 extends coaxially from the piston 21 projecting out of the right hand end of the slide member 17 and through the annular bush 12 to carry a connecting eye 24 or a similar connecting component, at the exterior of the bush 12. The bush 12 carries sealing rings 25 sealing the sliding interface of the piston rod 22 and the bush 12.

At its opposite axial ends respectively the slide member 17 is formed with radially inwardly extending flanges 26, 27 which define stop means in turn defining first and second limit positions of the axial movement of the piston head 21 relative to the slide member. In the first limit position of the piston assembly relative to the slide member 17 the right hand face of the piston head 21 abuts the flange 26, and in the second limit position the left hand face of the piston head 21 abuts the flange 27.

FIG. 1 illustrates the piston assembly 19 and the slide member 17 closely proximate their second axial limit positions. Movement of the parts from their second limit positions towards their first limit positions is extending movement of the actuator while movement of the piston assembly and slide member from their first limit positions towards their second limit positions is retract movement of the actuator. It will be recognised that in use the cylinder 11 will be fixed, and the connecting eye 24 of the piston rod 22 will be coupled to the component, for example a thrust reverse cowl, to be moved by the actuator. The invention is particularly concerned with retraction movement of the actuator of FIGS. 1 and 2 but it is convenient first to consider how the extension movement of the actuator is achieved.

In a very simplistic system it would be possible to extend the actuator by applying hydraulic fluid under pressure to the port 15 while venting the port 14 to low pressure. In such an arrangement high pressure would act on the left hand circular face of the piston 21 and on the left hand end of the slide member 17 while low pressure acts on the right hand end of the slide member 17 and on the annular face of the piston 21 encircling the piston rod 22. The pressure imbalance between the left and right hand ends of the piston assembly and slide member 17 would drive both components, relative to the cylinder 11, to the right to reach their first limit positions as shown in FIG. 2. Thereafter the abutment between the slide member 17 and the bush 12, or a part protruding therefrom, would arrest the slide member 17 and abutment of the piston head 21 with the flange 26 would arrest the movement of the piston assembly.

Generally however such a simplistic hydraulic system would not be used. Instead, as depicted in FIGS. 1 and 2 the port 14 is connected to a source 28 of hydraulic fluid under pressure through a line 29 containing restrictors 31 and 32 in series and a change-over valve 33 controls whether port 15 is connected through a line 35 to system low pressure 34 or alternatively connected to a point 36 in the high pressure line 29 intermediate the restrictors 31 and 32. A restrictor 37 is provided in the line 35.

FIG. 1 illustrates the change-over valve 33 in the “extend” position. It can be seen that the port 14 is connected to the high pressure source 28 through the line 29, and the port 15 is also connected to the high pressure source 28 through the line 35, the restrictor 37, the change-over valve 33, the restrictor 31 and the line 29. Thus hydraulic fluid at equal high pressures is supplied to both ends of the cylinder 11. It will be recognised that since equal surface areas of the slide member 17 at both axial ends thereof are exposed to the same pressure then there is no resultant force on the slide member 17 and it will not move. However, although both faces of the piston head 21 are also exposed to the same high pressure, the left hand face of the piston 21 is of significantly larger surface area than the annular, right hand face of the piston head 21 encircling the piston 22. Thus the piston assembly 19 is driven to the right from the position shown in FIG. 1 and slides relative to the slide member provided that the friction between the slide member 17 and the cylinder 11 exceeds the frictional engagement of the piston head 21 in the slide member 17. Assuming that this is the case then the piston assembly moves relative to the slide member 17 until the piston head 21 achieves its first limit position relative to the slide member 17 defined by abutment with the flange 26, whereafter the slide member 17 is carried by the piston assembly, during continued movement of the piston assembly, until the slide member 17 achieves its first limit position whereupon both the slide member and the piston assembly are arrested in their first limit positions.

Alternatively of course if friction between the piston head and the slide member exceeds the friction between the slide member and the cylinder then initially both the piston assembly and the slide member will move in unison until the slide member achieves its first limit position whereafter further movement of the slide member will be prevented but continued movement of the piston assembly relative to the slide member occurs until the piston head 21 abuts the flange 26 whereupon both the piston assembly and the slide member are in their first limit positions as shown in FIG. 2.

In order to retract the actuator from the position shown in FIG. 2 back towards the position shown in FIG. 1 the changeover valve 33 is moved from its first operative position shown in FIG. 1 to its second operative position as shown in FIG. 2. As is apparent from FIG. 2 in the second operative position of the change-over valve 33 the port 15 of the cylinder 11 is connected to the low pressure line of the associated hydraulic system, and thus effectively is vented to low pressure. However, the high pressure connection to the port 14 through the restrictors 31, 32 is maintained and initially therefore high pressure is applied to the right hand end of the slide member 17 and the right hand, annular face of the piston head 21 thereby driving the piston assembly and the slide member in unison towards their second limit positions (to the left in FIG. 2). Since both the slide member 17 and the piston head are moving in unison there is a relatively large swept volume of the cylinder 11, and consequently a relatively large volume of hydraulic fluid needs to be supplied to the cylinder. However, it will be recalled that the permitted stroke of the slide member 17 in the cylinder 11 is significantly less than the permitted stroke of the piston assembly, and when the guide member 17 has moved through a distance equal to l₁ minus l₂ the slide member will achieve its second limit position, and will be arrested by abutment with the end cap 13.

Thereafter high pressure continues to be applied to the annular right hand surface of the piston head 21 and the piston assembly continues to move within the slide member 17 until the piston head abuts the flange 27. During movement of the piston assembly relative to the slide member 17, the swept volume within the cylinder 11 is significantly less (by an amount equal to the wall volume of the slide member 17), and thus the volume of hydraulic fluid under pressure which must be supplied to complete the retraction movement of the actuator is significantly reduced.

In the position shown in FIG. 2 it will be appreciated that the piston head 21 is in engagement with the abutment defined by the flange 26. It will be recognised therefore that in the initial part of the retraction movement the slide member is acting, in effect, as additional surface area of the piston head 21 and so the retraction force generated by the actuator is greater during the initial retraction movement than during the subsequent part of the retraction movement where the piston assembly is moving relative to the slide member 17. Such an actuator is particularly suited to operation of an aircraft gas turbine engine thrust reverser system where initial retraction movement of the cowls of the thrust reverser system requires a greater force than that required during the remainder of the retraction movement.

FIGS. 3 and 4 are similar to FIGS. 1 and 2 but illustrate a modified linear actuator. Components of the actuator of FIGS. 3 and 4 common to the actuator of FIGS. 1 and 2 carry the same reference numerals the modified actuator differing by the addition of components. The operation of the actuator of FIGS. 3 and 4 in retract mode is exactly the same as is described above with reference to FIGS. 1 and 2, but the additional components, described hereinafter, alter the operation of the linear actuator during extend mode operation.

The piston assembly 19 of the actuator of FIGS. 3 and 4 is hollow, defining an elongate cylindrical bore 41 within the piston assembly coaxial with the cylinder 11 and slide member 17. The bore 41 is open at the left hand face of the piston head 21, and closed at the outer free end of the piston rod 22, having an end face 42 at the interior of the free end of the piston. The face 42 is in two separate parts by virtue of the internal shaping of the piston rod.

Extending coaxially within the bore 41 of the piston assembly 19, from the end cap 13 of the cylinder 11, is a hollow, elongate rod, 43. The rod 43 is anchored at one end to the end cap 13, and terminates, at its opposite end, within the bore 41 adjacent the bush 12 of the cylinder 11. At its free end, remote from the end cap 13, the rod 43 carries an external collar 44 slidably engaging the surface of the bore 41 of the piston assembly. A sealing ring 45 carried by the collar 44 seals the sliding interface of the collar 44 and the wall of the bore 41. It will be recognised that the rod 43, the collar 44, and the seal 45 isolate an inner, end chamber 46 within the piston rod 22 from the interior of the cylinder 11, the face 42 being an end face of the chamber 46.

The hollow elongate rod 43 defines an internal passage 47 which communicates by way of a cross drilling 48 of the rod 43 with the interior of the cylinder 11 adjacent the hydraulic fluid port 15. At the opposite end of the passage 47, within the collar 44, there is provided a combined fluid flow restrictor and non-return valve 49. The valve 49 is a “leaky” non-return valve, typically a ball-valve as shown in FIGS. 3 and 4, or alternatively a poppet-valve. The valve closes to prevent flow of hydraulic fluid from the passage 47 into the chamber 46 but is arranged to be “leaky” so as to define in its closed position, a restricted flow path from the passage 47 into the chamber 46. The valve is arranged to open to permit flow from the chamber 46 into the passage 47 with little or no restriction. Thus in its closed position the valve 49 allows a limited flow into the chamber 46 from the passage 47 and thus defines a flow restrictor.

Considering the actuator components in the positions shown in FIG. 3, adjacent the commencement of an extend mode operation of the actuator hydraulic fluid under pressure will flow through the port 15 into the left hand end of the cylinder 11 and will act upon the piston assembly 19 to move the piston assembly to extend the actuator by moving the piston assembly to the right. It will recognised that because the same fluid pressure is applied to the right hand end of the cylinder 11 by way of the port 14 then the force causing movement of the piston assembly to the right will be as a result of the different piston areas exposed to the pressure at the left and right hand ends of the cylinder 11 respectively. It can be seen that at the left hand end of the piston assembly the area exposed to pressure is greater, by the area of the end surface of the piston rod 22, than the area exposed to pressure to in the right hand of the cylinder 11. Thus there is a resultant movement to the right. However, simultaneously hydraulic fluid under pressure from the left hand end of the cylinder 11 is flowing through the cross drilling 48, the passage 47 and the restrictor defined by the leaky valve 49, into the chamber 46 of the piston assembly, and thus there is an additional “left hand area” 42 of the piston assembly which is exposed to high pressure.

Initially therefore if the resistance to movement of the piston assembly is high, as may be the case when deploying a thrust reverser cowl from its stowed position towards its operative position, the speed of movement of the piston assembly will be very slow, and the effect of pressure on the surface 42 of the chamber 46 will augment the effect of the pressure acting on the left hand face of the piston assembly to generate force moving the piston, and thus to overcome the initial resistance to movement of, for example, the thrust reverser cowl. Thereafter the load on the piston may decrease, so that the speed of movement of the piston can increase. In these circumstances the flow of fluid through the restrictor defined by the valve 49 is insufficient to maintain high pressure in the chamber 46, and thus the surface 42 will no longer augment the remainder of the piston surface and the piston will be driven by the effect of fluid pressure on the left hand face of the piston rod 22.

It will be recognised further that should subsequent resistance to movement of the piston assembly be encountered, then movement of the piston assembly will slow, or cease, and again pressure in the chamber 46 will be able to increase permitting the surface 42 to assist the left hand end surface of the piston rod 22 in driving the piston assembly in its extend direction.

During retract movement of the piston assembly the port 15 is connected to low pressure, and the valve 49 opens so that fluid discharged from the chamber 46, as the volume of the chamber 46 reduces during retraction movement of the piston assembly, flows substantially without restriction, through the valve 49, the passage 47 and the cross drilling 48 into the left hand end of the cylinder 11 to exit through the port 15.

It will be understood that throughout a significant proportion of the extend stroke of the actuator of FIGS. 3 and 4, the volume of hydraulic fluid under pressure which must be supplied to operate the actuator is less than would be the case with the actuator as described above with reference to FIGS. 1 and 2. Thus the actuator can operate with a high pressure fluid supply system of lower capacity than would otherwise be the case, notwithstanding the fact that full operating force is achieved at those points in the extend movement of the actuator at which otherwise the actuator might stall.

1. A linear hydraulic actuator comprising,
an outer hydraulic cylinder of internal axial length l₁,
a hollow cylindrical slide member of axial length l₂, where l₂ is less than l₁, said slide member being received coaxially within said outer cylinder and being engaged in sealed sliding relationship with the inner surface of said outer cylinder,
a piston assembly received coaxially within said outer cylinder and said slide member and including a piston head engaged in sealed sliding relationship with the inner surface of said slide member and a piston rod extending from one axial end of said piston head and further extending, in sealed sliding relationship, through one end of said outer cylinder,
first stop means defining first and second axially spaced limit positions of the axial movement of said slide member relative to said outer cylinder, and
second stop means defining first and second axially spaced limit positions of the axial sliding movement of said piston assembly relative to said slide member,
whereby, in use, with said piston assembly at said first limit position of its axial movement relative to said slide member and said slide member at said first limit position of its axial movement relative to the outer cylinder, then application of hydraulic fluid pressure to the interior of said outer cylinder, at one axial end thereof, simultaneously drives the slide member and the piston assembly away from their respective first limit positions towards their respective second limit positions, said hydraulic pressure acting on both the exposed area of the piston head and on the annular end surface of said slide member, said movement of said slide member and said piston assembly in unison continuing until said slide member is arrested in its second limit position by said first stop means, whereafter said piston assembly continues to move, sliding within the slide member under the action of hydraulic pressure applied to the exposed area of the piston head, until the piston assembly is arrested in its second limit position relative to the slide member by said second stop means.

2. An actuator according to claim 1, wherein hydraulic fluid under pressure can be admitted to, and discharged from, the interior of said cylinder at said one axial end thereof through a first fluid port and a second fluid port is provided adjacent the opposite axial end of the cylinder for the admission, or discharge of hydraulic fluid.

3. An actuator according to claim 1, wherein said piston assembly and said slide member can be driven hydraulically from their second limit positions towards their first limit positions by hydraulic fluid pressure at the opposite axial end of said cylinder.

4. An actuator according to claim 1, wherein a change-over valve controls the connection of at least one of said first and said opposite axial ends of the cylinder to high pressure and low pressure lines.

5. An actuator according to claim 1, wherein hydraulic fluid under equal high pressure can be supplied to both axial ends of said cylinder when moving said piston assembly and said slide member from said second limit positions towards said first limit positions so that hydraulic pressures acting on the slide member are balanced, and said side member is moved to its first limit position by the piston assembly.

6. An actuator according to claim 1, wherein said piston assembly is hollow and at the end of the cylinder remote from the piston rod the cylinder defines a pressure chamber the wall of which is defined in part by an annular end surface of said hollow piston assembly, the actuator further including sealing means fixed with respect to said cylinder and slidably engaging the interior surface of said hollow piston assembly to isolate an inner, closed, end chamber of said hollow piston assembly from said pressure chamber, and, a fluid path between said inner, closed, end chamber of said hollow piston assembly and a port of said actuator connected in use to a pressurised hydraulic fluid supply line, said fluid flow path including a flow restrictor whereby the rate at which hydraulic fluid can enter said inner, closed, end chamber of said hollow piston assembly from said supply line is less than the rate at which the volume of said inner, closed end chamber increases as said piston assembly is moved by the application of hydraulic fluid to said pressure chamber.

7. An actuator according to claim 6, wherein a non-return valve is associated with said fluid flow path so that during movement of said piston assembly relative to said cylinder to discharge hydraulic fluid from the interior of the piston assembly through said path, said valve opens so that fluid discharged from the interior of said inner, closed end chamber is not required to flow through said restrictor.

8. An actuator according to claim 7, wherein said sealing means is carried by a rod disposed coaxially within said hollow piston assembly and secured to the cylinder.

9. An actuator according to claim 8, wherein said fluid flow path includes a passage extending through said rod.

10. An actuator according to claim 8, wherein said non-return valve is carried by said rod.

11. An actuator according to claim 9, wherein said passage through said rod interconnects said pressure chamber and said end chamber.

12. An actuator according to claim 7, wherein said restrictor and said non-return valve are defined by a common component in the form of a non-return valve which leaks in its closed position to permit a restricted flow of hydraulic fluid from said supply line to said end chamber.
